(19) United States
(12) Patent Application Publication
(10) Pub. No.: US 2025/0183316 A1
(43) Pub. Date: Jun. 5, 2025

(54) ALL-SOLID-STATE RECHARGEABLE BATTERIES

(71) Applicant: SAMSUNG SDI CO., LTD., Yongin-si, Gyeonggi-do (KR)

(72) Inventors: Jin-Woo KIM, Yongin-si (KR); Myoungki MIN, Yongin-si (KR); Heetaek PARK, Yongin-si (KR)

(21) Appl. No.: 18/845,168

(22) PCT Filed: Dec. 19, 2022
(86) PCT No.: PCT/KR2022/020684

§ 371 Date: Sep. 9, 2024

(30) Foreign Application Priority Data
Mar. 8, 2022 (KR) 10-2022-0029637

(51) Int. Cl. H01M 4/62; H01M 4/02; H01M 4/131; H01M 4/36; H01M 4/525

(52) U.S. Cl. CPC H01M 4/628; H01M 4/131; H01M 4/366; H01M 4/525; H01M 4/625; H01M 2004/028

(57) ABSTRACT

Disclosed is an all-solid-state rechargeable battery that includes a positive electrode, a negative electrode, and a solid electrolyte layer between the positive electrode and the negative electrode, wherein the positive electrode includes a current collector and a positive electrode active material layer on the current collector, and the positive electrode active material layer includes a positive electrode active material, a sulfide-based solid electrolyte, and a conductive material, and the conductive material includes a carbon material having an aspect ratio of greater than or equal to 2 and a metal oxide on a surface of the carbon material, and the metal oxide includes a metal selected from Ca, Co, Ga, K, Mg, Na, Nb, Sn, Ti, V, Zn, Zr, and a combination thereof.

### TECHNICAL FIELD

All-solid-state rechargeable battery is disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire in the event of collision, penetration, and the like. Accordingly, a semi-solid battery or all-solid-state battery that avoids the use of electrolyte solutions is being proposed. An all-solid-state battery is a battery in which all materials are made of solid, particularly a battery that uses solid electrolytes. This all-solid-state battery has the merit of not being charged as there is no risk of explosion due to electrolyte solution leakage and the like, and that it is easy to manufacture a thin battery.

It is known that the electronic conductivity can be improved by applying carbon materials with a large aspect ratio, such as carbon nanotubes, as conductive materials to the electrodes of all-solid-state batteries. However, as the content of these conductive agents increases, there is a problem in that the solid electrolyte deteriorates due to side reactions at the interface between the conductive agent and the solid electrolyte. Therefore, research is needed to reduce the reactivity of the conductive material and solid electrolyte in all-solid-state batteries.

### DISCLOSURE

### Technical Problem

In an all-solid-state rechargeable battery, the reactivity between a conductive material and a solid electrolyte is lowered, thereby suppressing deterioration of the solid electrolyte and improving cycle-life characteristics of the all-solid-state rechargeable battery.

### Technical Solution

In an embodiment, an all-solid-state rechargeable battery includes a positive electrode, a negative electrode, and a solid electrolyte layer between the positive electrode and the negative electrode, wherein the positive electrode includes a current collector and a positive electrode active material layer on the current collector, and the positive electrode active material layer includes a positive electrode active material, a sulfide-based solid electrolyte, and a conductive material, and the conductive material includes a carbon material having an aspect ratio of greater than or equal to 2 and a metal oxide on a surface of the carbon material, and the metal oxide includes a metal selected from Ca, Co, Ga, K, Mg, Na, Nb, Sn, Ti, V, Zn, Zr, and a combination thereof.

### Advantageous Effects

The reactivity between the conductive material and the solid electrolyte in the positive electrode of an all-solid-state rechargeable battery is reduced, thereby suppressing deterioration of the solid electrolyte, and thus improving the performance, such as cycle-life characteristics, of the all-solid-state rechargeable battery.

### DESCRIPTION OF THE DRAWINGS

FIGS. 1 and 2 are schematic cross-sectional views of an all-solid-state rechargeable battery according to embodiments.

FIG. 3 is a transmission electron microscope photograph of the conductive material of Synthesis Example 1.

FIG. 4 is a scanning transmission electron microscope photograph of the conductive material of Synthesis Example 1.

FIG. 5 is a scanning transmission electron microscope-energy dispersive spectroscopic analysis photograph of the conductive material of Synthesis Example 1.

FIG. 6 is a transmission electron microscope photograph of Comparative Synthesis Example 1 and the conductive material of Synthesis Example 1.

FIG. 7 is a graph of current change according to energy potential of the electrode plates to which the conductive materials of Synthesis Examples 1 and 2 and Comparative Synthesis Examples 1 and 2 are applied.

FIG. 8 is an X-ray spectroscopy analysis graph of a lithium-zirconium composite oxide.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter and average size may be measured by a method well known to those skilled in the art, for example, may be measured by a particle size analyzer, or may be measured by a transmission electron microscopic photograph or a scanning electron microscopic photograph. Alternatively, it is possible to obtain an average particle diameter value by measuring a size using a dynamic light scattering method, performing data analysis, counting the number of particles for each particle size range, and calculating from this. As used herein, when a definition is not otherwise provided, the average particle diameter is the diameter (D50) of particles having a cumulative volume of 50 volume % in the particle size distribution as measured by a particle size analyzer. As used herein, when a definition is not otherwise provided, the average particle diameter means a diameter (D50) of particles having a cumulative volume of 50 volume % in the particle size distribution that is obtained by measuring the size (diameter or major axis length) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

In an embodiment, an all-solid-state rechargeable battery includes a positive electrode, a negative electrode, and a solid electrolyte layer between the positive electrode and the negative electrode, wherein the positive electrode includes a current collector and a positive electrode active material layer on the current collector, and the positive electrode active material layer includes a positive electrode active material, a sulfide-based solid electrolyte, and a conductive material, and the conductive material includes a carbon material having an aspect ratio of greater than or equal to 2 and a metal oxide on a surface of the carbon material, and the metal oxide includes a metal selected from Ca, Co, Ga, K, Mg, Na, Sn, Ti, V, Zn, Zr, and a combination thereof. The conductive material has very high electrical conductivity and low reactivity with a sulfide-based solid electrolyte, so that deterioration of the sulfide-based solid electrolyte due to the conductive material is suppressed, and thus the cycle-life characteristics of the all-solid-state rechargeable battery may be improved.

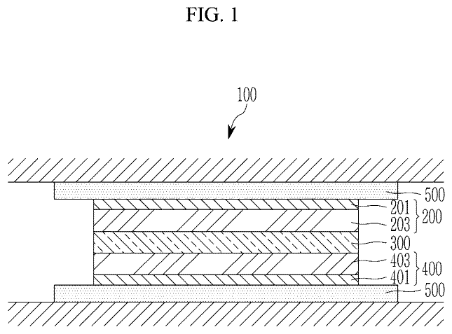

FIG. 1 is a cross-sectional view of an all-solid-state rechargeable battery according to an embodiment. Referring to FIG. 1, the all-solid-state rechargeable battery 100 has a structure in which an electrode assembly including a negative electrode 400 including a negative electrode current collector 401 and a negative electrode active material layer 403, a solid electrolyte layer 300, and a positive electrode 200 including a positive electrode current collector 201 and a positive electrode active material layer 203 are stacked is housed in a battery case such as a pouch. FIG. 1 illustrates one electrode assembly including a negative electrode 400, a solid electrolyte layer 300 and a positive electrode 200, but an all-solid-state rechargeable battery may be manufactured by stacking two or more electrode assemblies.

The all-solid-state rechargeable battery 100 may further include an elastic sheet 500 on the outer side of at least one of the positive electrode 200 and the negative electrode 400. The elastic sheet 500 may be expressed as a buffer layer or an elastic layer, and serves to ensure that pressure is uniformly transmitted to the electrode stack, thereby improving contact between solid components, and also to relieve stress transmitted to the solid electrolyte, etc., and can serve to suppress cracks from occurring in the solid electrolyte due to stress accumulation according to changes in the thickness of the electrode during charging and discharging.

### Positive Electrode

### Conductive Material

In the metal oxide, the metal may be one selected from Ca, Co, Ga, K, Mg, Na, Nb, Sn, Ti, V, Zn and Zr or a combination of two or more. These metal oxides may be located on the surface of the carbon material having the aspect ratio of greater than or equal to 2, and may drastically reduce the reactivity with sulfide-based solid electrolytes even in small amounts without deteriorating the electrical conductivity of the carbon material. The metal oxide may be a material used as a positive electrode active material or a buffer layer of a positive electrode active material layer in the field of all-solid-state rechargeable batteries. Accordingly, it is possible to simultaneously coat positive electrode active material and conductive material, which can also increase process efficiency.

The metal oxide may be in contact or bonded in the form of particles on the surface of the carbon material having the aspect ratio of greater than or equal to 2, or may be coated in the form of islands, or may be coated in the form of a film. That is, the metal oxide may be present as a coating layer on the surface of the carbon material having the aspect ratio of greater than or equal to 2. The conductive material may also be expressed as the carbon material having the aspect ratio of greater than or equal to 2, and a coating layer located on the surface of the carbon material and containing the metal oxide. In any coating form, the metal oxide can reduce the reactivity of conductive materials and sulfide-based solid electrolytes without deteriorating the electrical conductivity.

For example, the metal oxide may be present in the form of particles on the surface of the carbon material having the aspect ratio of greater than or equal to 2. In this case, the size of the particle may be 0.5 nm to 30 nm, for example 0.5 nm to 20 nm, 0.5 nm to 25 nm, 0.5 nm to 10 nm, 1 nm to 15 nm, or 1 nm to 10 nm. In this case, the metal oxide is advantageous in suppressing the degradation of the solid electrolyte by lowering the reactivity of the conductive material and the sulfide-based solid electrolyte without deteriorating the electronic conductivity. Herein, the particle size may be measured by observing it with an optical microscope such as a transmission electron microscope. For example, the size of the particles may mean the average particle diameter (D50), in which case the particle size distribution may be obtained by randomly measuring the sizes (diameter or major axis length) of about 50 particles in an optical microscope photograph, and the size of particles having a cumulative volume of 50 volume % in the particle size distribution may be taken as the average particle diameter.

For example, the metal oxide may be present in the form of crystalline particles, or in the form of mixed non-crystalline and crystalline particles. At this time, for example, the size of the crystallite on the (011) plane may be 1 nm to 20 nm, or 1 nm to 10 nm.

Depending on the synthesis method, the metal oxide may be coated in an island shape or a film shape on the surface of the carbon material having the aspect ratio of greater than or equal to 2, and the thickness of the coating layer may be 0.5 nm to 50 nm, for example, 0.5 nm to 40 nm, 0.5 nm to 30 nm, 0.5 nm to 20 nm, 1 nm to 15 nm, or 1 nm to 10 nm. When this thickness range is satisfied, the reactivity between the conductive material and the sulfide-based solid electrolyte may be effectively reduced while maintaining the electrical conductivity of the conductive material.

The metal oxide is for example zirconium oxide, titanium oxide, zinc oxide, vanadium oxide, zinc titanium oxide, a composite thereof, or a combination thereof.

For example, the metal oxide may further include lithium in addition to the metal elements such as Ca, Co, Ga, K, Mg, Na, Nb, Sn, Ti, V, Zn, and Zr mentioned above. That is, the metal oxide may be a lithium-metal composite oxide, wherein the metal is one of the elements listed above. For example, the metal oxide may include a lithium zirconium composite oxide, a lithium titanium composite oxide, a lithium zinc composite oxide, a lithium vanadium composite oxide, a composite thereof, or a combination thereof. Such lithium-metal composite oxides may lower the reactivity between the conductive material and the sulfide-based solid electrolyte while facilitating the movement of lithium ions and electrons, thereby inhibiting the deterioration of the solid electrolyte and improving the cycle-life characteristics of the all-solid-state rechargeable battery.

On the surface of the carbon material having the aspect ratio of greater than or equal to 2, in addition to the metal oxide described above, a metal carbide, a metal hydroxide, or a combination thereof may be present, and further, lithium carbonate, lithium oxide, lithium hydroxide, or a combination thereof may be present. These may form a composite with the aforementioned metal oxides.

The metal oxide may be included in an amount of 0.05 parts by mole to 5 parts by mole, for example 0.05 parts by mole to 4 parts by mole, 0.05 parts by mole to 3 parts by mole, 0.05 parts by mole to 2 parts by mole, 0.1 parts by mole to 1 parts by mole, or 0.1 parts by mole to 0.5 parts by mole based on 100 parts by mole of the carbon material having the aspect ratio of greater than or equal to 2. When included in such a content, the reactivity between the conductive material and the sulfide-based solid electrolyte can be sufficiently lowered without lowering the electronic conductivity of the carbon material, thereby improving the cycle-life characteristics of the all-solid-state rechargeable battery.

The carbon material having an aspect ratio of greater than or equal to 2 may include, for example, a carbon nanotube, a carbon nanofiber, a carbon nanowire, or a combination thereof. Here, the aspect ratio of the carbon material may mean a ratio of the length to the diameter of the cross-section, and may be, for example, 2 to 50, 2 to 40, 2 to 30, 3 to 20, or 5 to 15. These carbon materials may maximize electronic conductivity in the positive electrode of an all-solid-state rechargeable battery, thereby improving efficiency and cycle-life characteristics. However, there is a problem that the contact rate with the solid electrolyte is high and a side reaction occurs at the interface between the solid electrolyte and carbon material during battery operation, causing the solid electrolyte to deteriorate. However, in an embodiment, by applying the aforementioned metal oxide to the surface of a carbon material having an aspect ratio of greater than or equal to 2, a high degree of electrical conductivity may be maintained while lowering the reactivity between the carbon material and the solid electrolyte, thereby suppressing the phenomenon of deterioration of the solid electrolyte.

The diameter of the cross-section of the carbon material having the aspect ratio of greater than or equal to 2 may be, for example, 0.1 nm to 100 nm, 0.5 nm to 50 nm, 1 nm to 20 nm, or 1 nm to 10 nm, and the length may be 1 nm to 100 μm, 10 nm to 50 μm, or 100 nm to 10 μm.

Examples of a method for positioning the metal oxide on the surface of the carbon material having the aspect ratio of greater than or equal to 2, i.e., a method for coating the metal oxide, include, but are not limited to, an evaporation method, an immersion method, a spray method, an atomic deposition method, etc. For example, the above-described conductive material may be manufactured by contacting a precursor of the metal oxide with the carbon material having the aspect ratio of greater than or equal to 2 by an evaporation method or the like and then heat-treating the carbon material at a temperature of 200° C. to 500° C.

The aforementioned conductive material may be included in an amount of 0.1 wt % to 5 wt %, for example, 0.2 wt % to 4 wt %, 0.5 wt % to 3 wt %, or 0.5 wt % to 2 wt % based on 100 wt % of the positive electrode active material layer. When included in this range, the efficiency of electron transfer in an all-solid-state rechargeable battery may be increased while preventing capacity reduction and effectively suppressing side reactions between the conductive material and the solid electrolyte.

### Positive Electrode Active Material

On the other hand, the positive electrode includes a protective layer on the surface of the positive electrode active material and/or the surface of the positive electrode active material layer, the protective layer includes a metal oxide including a metal selected from Ca, Co, Ga, K, Mg, Na, Nb, Sn, Ti, V, Zn, Zr, and a combination thereof. This protective layer is intended to suppress side reactions between the positive electrode active material and the solid electrolyte in an all-solid-state rechargeable battery, and can be expressed as a surface protective layer or buffer layer. The protective layer may be in the form of a film or an island that uniformly surrounds the positive electrode active material and/or the positive electrode active material layer. Because the composition and type of the metal oxide are as described above, a detailed description is omitted.

The metal oxide of the protective layer may be the same material as the metal oxide in the aforementioned conductive material or may be a different material. For example, the metal oxide of the protective layer may be a zirconium-containing oxide and the metal oxide of the conductive material may be a titanium-containing oxide, and thus they may be different from each other, or the metal oxide of the protective layer and the metal oxide of the conductive material may both be the same as a lithium zirconium composite oxide. When coating the positive electrode active material and the conductive material simultaneously, the protective layer of the positive electrode active material and the metal oxide of the conductive material may include the same components, and in this case, there is an advantage of process efficiency.

The positive electrode active material may be applied without limitation as long as it is a compound (lithiated intercalation compound) being capable of intercalating and deintercalating lithium. Examples of the positive electrode active material include compounds represented by one of the following chemical formulas:
LiₐA_{1-b}X_{b}D₂ (0.90≤a≤1.8, 0≤b≤0.5);
LiₐA_{1-b}X_{b}O_{2-c}D_{c} (0.90≤a≤1.8, 0≤b≤0.5, 0≤c≤0.05);
LiₐE_{1-b}X_{b}O_{2-c}D_{c} (0.90≤a≤1.8, 0≤b≤0.5, 0≤c≤0.05);
LiₐE_{2-b}X_{b}O_{4-c}D_{c} (0.90≤a≤1.8, 0≤b≤0.5, 0≤c≤0.05);
LiₐNi_{1-b-c}Co_{b}X_{c}D_{α} (0.90≤a≤1.8, 0≤b≤0.5, 0≤c≤0.5, 0<α≤2);
LiₐNi_{1-b-c}Co_{b}X_{c}O_{2-α}T_{α} (0.90≤a≤1.8, 0≤b≤0.5, 0≤c≤0.05, 0<α<2);
LiₐNi_{1-b-c}Co_{b}X_{c}O_{2-α}T₂ (0.90≤a≤1.8, 0≤b≤0.5, 0≤c≤0.05, 0<α<2);
LiₐNi_{1-b-c}Mn_{b}X_{c}D_{α} (0.90≤a≤1.8, 0≤b≤0.5, 0≤c≤0.05, 0<α≤2);
LiₐNi_{1-b-c}Mn_{b}X_{c}O_{2-α}T_{α} (0.90≤a≤1.8, 0≤b≤0.5, 0≤c≤0.05, 0<α<2);
LiₐNi_{1-b-c}Mn_{b}X_{c}O_{2-α}T₂ (0.90≤a≤1.8, 0≤b≤0.5, 0≤c≤0.05, 0<α<2);
LiₐNi_{b}E_{c}G_{d}O₂ (0.90≤a≤1.8, 0≤b≤0.9, 0≤c≤0.5, 0.001≤d≤0.1);
LiₐNi_{b}Co_{c}Mn_{d}GₑO₂ (0.90≤a≤1.8, 0≤b≤0.9, 0≤c≤0.5, 0≤d≤0.5, 0.001≤e≤0.1);
LiₐNiG_{b}O₂ (0.90≤a≤1.8, 0.001≤b≤0.1);
LiₐCoG_{b}O₂ (0.90≤a≤1.8, 0.001≤b≤0.1);
LiₐMn_{1-b}G_{b}O₂ (0.90≤a≤1.8, 0.001≤b≤0.1);
LiₐMn₂G_{b}O₄ (0.90≤a≤1.8, 0.001≤b≤0.1);
LiₐMn_{1-g}G_{g}PO₄ (0.90≤a≤1.8, 0≤g≤0.5);
QO₂; QS₂; LiQS₂;
V₂O₅; LiV₂O₅;
LiZO₂;
LiNiVO₄;
Li_{(3-f)}J₂(PO₄)₃(0≤f≤2);
Li_{(3-f)}Fe₂(PO₄)₃(0≤f≤2);
LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium manganese oxide (LMO), or lithium iron phosphate (LFP).

The positive electrode active material may include, for example, at least one lithium-metal composite oxide represented by Chemical Formula 11.

LiₐM¹¹_{1-y11-z11}M¹²_{y11}M¹³_{z11}O₂ [Chemical Formula 11]

In Chemical Formula 11, 0.9≤a≤1.8, 0≤y11≤1, 0≤z11≤1, 0≤y11+z11<1, and M¹¹, M¹², and M¹³ are each independently Ni, Co, Mn, Al, Mg,

Ti, Fe, or a combination thereof.

For example, M¹¹ may be Ni, and M¹² and M¹³ may each independently be a metal such as Co, Mn, Al, Mg, Ti or Fe. In a specific implementation example, M¹¹ may be Ni, M¹² may be Co, and M¹³ may be Mn or Al, but are not limited thereto.

In an embodiment, the positive electrode active material may include a lithium nickel-based composite oxide represented by Chemical Formula 12.

Liₐ₁₂Niₓ₁₂M¹⁴_{y12}M¹⁵_{1-x12-y12}O₂ [Chemical Formula 12]

In Chemical Formula 12, 0.9≤a12≤1.8, 0.3≤x12≤1, 0≤y12≤0.7, and M¹⁴ and M¹⁵ are each independently Al, B, Ba, Ca, Ce, Co, Cr, F, Fe, Mg, Mn, Mo, Nb, P, S, Si, Sr, Ti, V, W, Zr, or a combination thereof.

The positive electrode active material may include, for example, a lithium nickel cobalt-based oxide represented by Chemical Formula 13.

Liₐ₁₃Niₓ₁₃Co_{y13}M¹⁶_{1-x13-y13}O₂ [Chemical Formula 13]

In Chemical Formula 13, 0.9≤a13≤1.8, 0.3≤x13<1, 0<y13≤0.7, and M¹⁶ is Al, B, Ba, Ca, Ce, Cr, F, Fe, Mg, Mn, Mo, Nb, P, S, Si, Sr, Ti, V, W, Zr, or a combination thereof.

In Chemical Formula 13, 0.3≤x13≤0.99 and 0.01≤y13≤0.7; 0.4≤x13≤0.99 and 0.01≤y13≤0.6; 0.5≤x13≤0.99 and 0.01≤y13≤0.5; 0.6≤x13≤0.99 and 0.01≤y13≤0.4; 0.7≤x13≤0.99 and 0.01≤y13≤0.3; 0.8≤x13≤0.99 and 0.01≤y13≤0.2; or 0.9≤x13≤0.99 and 0.01≤y13≤0.1.

A nickel content in the lithium nickel-based composite oxide may be greater than or equal to 30 mol %, for example, greater than or equal to 40 mol %, greater than or equal to 50 mol %, greater than or equal to 60 mol %, greater than or equal to 70 mol %, greater than or equal to 80 mol %, or greater than or equal to 90 mol %, and may be less than or equal to 99.9 mol %, or less than or equal to 99 mol %, based on a total amount of metals excluding lithium. For example, in a lithium nickel composite oxide, the nickel content may be higher than the respective contents of other metals, such as cobalt, manganese, and aluminum. When the nickel content satisfies the above range, the positive electrode active material may exhibit excellent battery performance while implementing high capacity.

The average particle diameter (D50) of the positive electrode active material may be 1 μm to 25 μm, for example 4 μm to 25 μm, 5 μm to 20 μm, 8 μm to 20 μm, or 10 μm to 18 μm. A positive electrode active material having this particle size range can be harmoniously mixed with other components within the positive electrode active material layer and realize high capacity and high energy density.

The above-mentioned positive electrode active material may be in the form of a secondary particle formed by agglomeration of a plurality of primary particles, or may be in the form of a single particle having a monolithic structure. Additionally, the positive electrode active material may have a spherical or nearly spherical shape, or may be polyhedral or irregular.

Based on a total weight of the positive electrode active material layer, the positive electrode active material may be included in an amount of 55 wt % to 99.8 wt %, for example, 74 wt % to 89.8 wt %. When included in the above range, the capacity of an all-solid-state rechargeable battery can be maximized while improving its life characteristics.

### Sulfide-Based Solid Electrolyte

The sulfide-based solid electrolyte may include for example Li₂S-P₂S₅, Li₂S—P₂S₅-LiX (wherein X is a halogen element), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are each integers, and Z is Ge, Zn, or Ga), Li₂S—GeS₂, Li₂S—SiS₂—Li₃PO₄, Li₂S—SiS₂—LiₚMO_{q} (wherein p and q are each integers, and M is P, Si, Ge, B, Al, Ga, or In), or a combination thereof.

For example, the sulfide-based solid electrolyte may include an argyrodite-type sulfide. The argyrodite-type sulfide may be, for example, LiₐM_{b}P_{c}S_{d}Aₑ (wherein a, b, c, d, and e are all 0 or more and 12 or less, M is Ge, Sn, Si, or a combination thereof, and A is F, Cl, Br, or I), and specifically, may be Li₃PS₄, Li₇P₃S₁₁, Li₆PS₅Cl, Li₆PS₅Br, Li₆PS₅I, etc. These argyrodite-type sulfides have high ionic conductivity close to the ionic conductivity of typical liquid electrolytes at room temperature, which is in the range of 10⁻⁴ to 10⁻² S/cm, and thus can form close bonds with positive electrode active materials, etc., without causing a decrease in ionic conductivity, and further can form a close interface between the electrode layer and the solid electrolyte layer. An all-solid-state rechargeable battery including this can have improved battery performances such as rate capability, coulombic efficiency, and cycle-life characteristics.

The sulfide-based solid electrolyte may be amorphous or crystalline, or may be a mixture of the two.

The sulfide-based solid electrolyte is in the form of particles, and the average particle diameter (D50) thereof may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. A sulfide-based solid electrolyte satisfying this particle size range can effectively penetrate between positive electrode active materials, and has excellent contact with the positive electrode active material and connectivity between electrolyte particles. The average particle size may be obtained by randomly measuring the size (diameter or major axis length) of about 50 particles in an optical microscope photograph such as a scanning electron microscope to obtain a particle size distribution, and taking the diameter (D50) of particles having a cumulative volume of 50 volume % in the particle size distribution as the average particle size.

The positive electrode may further include an oxide-based inorganic solid electrolyte in addition to the aforementioned sulfide-based solid electrolyte. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr; x is an integer of 1 to 10), or a mixture thereof.

Based on a total weight of the positive electrode active material layer, the solid electrolyte may be included in an amount of 0.1 wt % to 45 wt %, for example, 1 wt % to 35 wt %, 5 wt % to 30 wt %, 8 wt % to 25 wt %, or 10 wt % to 20 wt %. Additionally, in the positive electrode active material layer, the positive electrode active material may be included in an amount of 65 wt % to 99 wt % and the solid electrolyte in an amount of 1 wt % to 35 wt %, for example, the positive electrode active material may be included in an amount of 80 wt % to 90 wt % and the solid electrolyte in an amount of 10 wt % to 20 wt % based on a total weight of the positive electrode active material and the solid electrolyte. When the above solid electrolyte is included in the positive electrode in such a content, the efficiency and cycle-life characteristics of the all-solid-state rechargeable battery can be improved without reducing the capacity.

### Binder

The positive electrode active material layer may optionally further include a binder. The binder serves to attach the positive electrode active material particles well to each other and also to attach the positive electrode active material well to the current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, a vinylidenefluoride-hexafluoropropylene copolymer, polyethylene, polypropylene, a styrene butadiene rubber, an acrylated styrene butadiene rubber, polyacrylonitrile, an epoxy resin, nylon, poly(meth)acrylate, polymethyl(meth)acrylate, and the like, but are not limited thereto.

The binder may be included in an amount of 0 wt % to 5 wt %, 0.1 wt % to 4 wt %, or 0.1 wt % to 3 wt % based on a total weight of each component of the positive electrode for the all-solid-state rechargeable battery, or based on a total weight of the positive electrode active material layer. Within the above content range, the binder may sufficiently exhibit adhesive ability without deteriorating battery performance.

The current collector of the positive electrode may be aluminum, but is not limited thereto.

In an embodiment, a method for manufacturing a positive electrode for an all-solid-state rechargeable battery is provided, including: contacting a positive electrode active material and a carbon material having an aspect ratio of greater than or equal to 2 with a metal oxide precursor to perform simultaneous coating, thereby simultaneously obtaining a positive electrode active material having a protective layer formed thereon, and a conductive material including a carbon material having an aspect ratio of greater than or equal to 2 and a metal oxide located on a surface thereof; mixing the obtained positive electrode active material and conductive material with a sulfide-based solid electrolyte and optionally a binder to prepare a positive electrode composition; and coating and drying the positive electrode composition on a positive electrode current collector.

The positive electrode for an all-solid-state rechargeable battery manufactured in this manner may effectively suppress side reactions between the conductive material and the sulfide-based solid electrolyte and between the positive electrode active material and the sulfide-based solid electrolyte while maintaining high electrical conductivity, thereby improving the cycle-life characteristics of the all-solid-state rechargeable battery. In addition, by simultaneously coating the positive electrode active material and carbon material, process efficiency and economy can be secured.

The method for simultaneously coating the positive electrode active material and the carbon material may be a dry coating method or a wet coating method, and for example, an evaporation method, an immersion method, a spray method, an atomic deposition method, etc. can be applied. For example, simultaneous coating may be performed by contacting a metal oxide precursor with a positive electrode active material and a carbon material by an evaporation method and then heat-treating at 200° C. to 500° C. As another example, simultaneous coating may be performed by dry mixing a metal oxide precursor with a positive electrode active material and a carbon material and then heat treating at 200° C. to 500° C.

### Negative Electrode

The negative electrode for an all-solid-state rechargeable battery may include, for example, a current collector and a negative electrode active material layer on the current collector. The negative electrode active material layer may include a negative electrode active material, and may further include a binder, a conductive material, and/or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy includes an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO2, Sn-R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be 10 wt % to 50 wt % based on the total weight of the silicon-carbon composite. In addition, the content of the crystalline carbon may be 10 wt % to 70 wt % based on the total weight of the silicon-carbon composite, and the content of the amorphous carbon may be 20 wt % to 40 wt % based on the total weight of the silicon-carbon composite. In addition, a thickness of the amorphous carbon coating layer may be about 5 nm to about 100 nm.

The average particle diameter (D50) of the silicon particles may be 10 nm to 20 μm, for example, 10 nm to 200 nm. The silicon particles may be present in an oxidized form, and at this time, an atomic content ratio of Si: O in the silicon particle indicating a degree of oxidation may be 99:1 to 33:67. The silicon particles may be SiOx particles, and in this case, the range of x in SiOx may be greater than 0 and less than 2.

The Si-based negative electrode active material or Sn-based negative electrode active material may be mixed with the carbon-based negative electrode active material. A mixing ratio of the Si-based negative electrode active material or Sn-based negative electrode active material with the carbon-based negative electrode active material may be a weight ratio of 1:99 to 90:10.

In the negative electrode active material layer, the negative electrode active material may be included in an amount of 95 wt % to 99 wt % based on the total weight of the negative electrode active material layer.

In an embodiment, the negative electrode active material layer further includes a binder, and may optionally further include a conductive material. The content of the binder in the negative electrode active material layer may be 1 wt % to 5 wt % based on the total weight of the negative electrode active material layer. In addition, when the conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may include, for example polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the above-mentioned negative binder, a cellulose-based compound capable of imparting viscosity may be further included. As this cellulose series compound, one or more types, such as carboxymethyl cellulose, hydroxypropyl methyl cellulose, methyl cellulose, or alkali metal salts thereof, may be used in mixture. The alkali metal may be Na, K, or Li. The amount of the thickener used may be 0.1 parts by weight to 3 parts by weight based on 100 parts by weight of the negative electrode active material.

The conductive material is included to provide electrode conductivity and any electrically conductive material may be used as a conductive material unless it causes a chemical change. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for the all-solid-state rechargeable battery may be a precipitation-type negative electrode. The precipitation-type negative electrode may be a negative electrode which has no negative electrode active material during the assembly of a battery but in which a lithium metal and the like are precipitated during the charge of the battery and serve as a negative electrode active material.

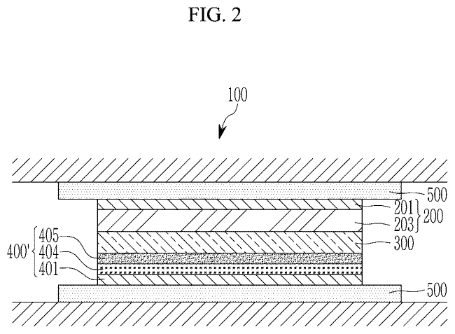

FIG. 2 is a schematic cross-sectional view of an all-solid-state rechargeable battery including a precipitation-type negative electrode. Referring to FIG. 2, the precipitation-type negative electrode 400′ may include the current collector 401 and a negative electrode coating layer 405 disposed on the current collector. The all-solid-state rechargeable battery having this precipitation-type negative electrode 400′ starts to be initially charged in absence of a negative electrode active material, and a lithium metal with high density and the like are precipitated between the current collector 401 and the negative electrode coating layer 405 during the charge and form a lithium metal layer 404, which may work as a negative electrode active material. Accordingly, the precipitation-type negative electrode 400′, in the all-solid-state rechargeable battery which is more than once charged, may include the current collector 401, the lithium metal layer 404 on the current collector, and the negative electrode coating layer 405 on the metal layer 404. The lithium metal layer 404 means a layer of the lithium metal and the like precipitated during the charge of the battery and may be called to be a metal layer, a negative electrode active material layer, or the like.

The negative electrode coating layer 405 may include lithiophilic metal, carbon material, or a combination thereof.

The lithiophilic metal may include, for example, gold, platinum, palladium, silicon, silver, aluminum, bismuth, tin, zinc, or a combination thereof, and may be composed of one type of these or may be composed of an alloy of several types. An average particle diameter (D50) of the above lithiophilic metal may be less than or equal to 4 μm, and may be, for example, 10 nm to 4 μm, 10 nm to 2 μm, or 10 nm to 1 μm.

The carbon material may be, for example, crystalline carbon, non-graphitic carbon, or a combination thereof. The crystalline carbon may be at least one selected from, for example, natural graphite, artificial graphite, mesophase carbon microbeads, and a combination thereof. The non-graphite carbon may be at least one selected from carbon black, activated carbon, acetylene black, denka black, ketjen black, furnace black, graphene, and a combination thereof.

When the negative electrode coating layer 405 includes both the metal and the carbon material, the mixing ratio of the metal and the carbon material may be, for example, a weight ratio of 1:10 to 1:2, 1:10 to 2:1, 5:1 to 1:1, or 4:1 to 2:1. In this case, the precipitation of lithium metal may be effectively promoted and the characteristics of the all-solid-state rechargeable battery can be improved. The negative electrode coating layer 405 may include, for example, a carbon material supported with a catalytic lithiophilic metal, or may include a mixture of lithiophilic metal particles and carbon material particles.

The negative electrode coating layer 405 may further include a binder, and the binder may be, for example, a conductive binder. In addition, the negative electrode coating layer 405 may further include general additives such as a filler, a dispersant, an ionic conductive agent.

A thickness of the negative electrode coating layer 405 may be, for example, 1 μm to 20 μm, 2 μm to 10 μm, or 3 μm to 7 μm. Additionally, the thickness of the negative electrode coating layer 405 may be 50% or less, 20% or less, or 5% or less of the thickness of the positive electrode active material layer. If the thickness of the negative electrode coating layer 405 is too thin, it may be collapsed by the lithium metal layer 404, and if it is too thick, the density of the all-solid-state rechargeable battery may decrease and the internal resistance may increase.

The precipitation-type negative electrode 400′ may further include a thin film, for example, on the surface of the current collector, that is, between the current collector and the negative electrode coating layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example, in a vacuum deposition method, a sputtering method, a plating method, and the like. The thin film may have, for example, a thickness of 1 nm to 800 nm, or 100 nm to 500 nm.

The lithium metal layer 404 may include lithium metal or a lithium alloy. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it may be difficult to perform the role of a lithium storage, and if it is too thick, the battery volume may increase and performance may deteriorate.

When such a precipitation-type negative electrode is applied, the negative electrode coating layer 405 may play a role in protecting the lithium metal layer 404 and suppressing the precipitation growth of lithium dendrite. Accordingly, short circuit and capacity degradation of the all-solid-state rechargeable battery can be suppressed and the cycle-life characteristics can be improved.

### Solid Electrolyte Layer

The solid electrolyte layer 300 includes a solid electrolyte, and may include the above-described sulfide-based solid electrolyte, oxide-based solid electrolyte, solid polymer electrolyte, etc. Because the sulfide-based solid electrolyte and oxide-based solid electrolyte are the same as those described for the positive electrode above, a detailed description is omitted.

The solid electrolyte layer may further include a binder in addition to the solid electrolyte. Herein, the binder may include a styrene butadiene rubber, polytetrafluoroethylene, polyvinylidene fluoride, polyethylene, an acrylate-based polymer, or a combination thereof, but is not limited thereto. The acrylate-based polymer may be, for example, butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyryl isobutyrate, xylene, toluene, benzene, hexane, or a combination thereof, or the compound represented by Chemical Formula 1 and/or Chemical Formula 2. Because a forming process of the solid electrolyte layer is well known in the art, a detailed description thereof will be omitted.

A thickness of the solid electrolyte layer may be, for example, 10 μm to 150 μm.

The solid electrolyte layer may further include an alkali metal salt and/or an ionic liquid and/or a conductive polymer.

The alkali metal salt may be, for example, a lithium salt. A content of the lithium salt in the solid electrolyte layer may be greater than or equal to 1 M, for example, 1 M to 4 M. In this case, the lithium salt may improve ion conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiF, LiCl, LiBr, LiI, LiB(C₂O₄)₂, LiPF₆, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoromethanesulfonyl)imide (LiTFSI), lithium bis(fluorosulfonyl)imide (LiFSI), LiCF₃SO₃, LiAsF₆, LiSbF₆, LiClO₄, or a mixture thereof.

Additionally, the lithium salt may be, for example, an imide type, and may include, for example, LiTFSI, LiFSI, or a combination thereof. The imide lithium salt may maintain or improve ionic conductivity by appropriately maintaining chemical reactivity with an ionic liquid.

The ionic liquid has a melting point below room temperature, so it is in a liquid state at room temperature and refers to a salt or room temperature molten salt composed of ions alone.

The ionic liquid may be a compound including at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, triazolium-based, and a mixture thereof, and at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer satisfying the above ranges may maintain or improve ion conductivity by improving the electrochemical contact area with the electrode. Accordingly, the energy density, discharge capacity, rate capability, etc. of the all-solid-state rechargeable battery may be improved.

An all-solid-state rechargeable battery according to an embodiment can be manufactured by sequentially stacking a positive electrode, a solid electrolyte, and a negative electrode to manufacture a stack, and then optionally bonding an elastic sheet to the outer surface of the positive electrode and/or the negative electrode and then preforming pressurization. The pressurization may be performed at a temperature of, for example, 25° C. to 90° C., and at a pressure of 550 MPa or less, or 500 MPa or less, for example, 400 MPa to 500 MPa. The pressurization may be, for example, an isostatic press, a roll press or a plate press.

The all-solid-state rechargeable battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, a coin type, a button type, a sheet type, a stack type, a cylindrical shape, a flat type, and the like. In addition, the aforementioned all-solid-state rechargeable battery can also be applied to medium and large-sized batteries used in electric vehicles, etc. For example, the aforementioned all-solid-state rechargeable battery can also be used in hybrid vehicles such as plug-in hybrid electric vehicles (PHEV). In addition, it can be applied to energy storage systems (ESS) that require a large amount of power storage, and can also be applied to electric bicycles or power tools.

### Mode for Invention

Hereinafter, examples and comparative examples of the present invention are described. The following examples are only examples of the present invention, and the present invention is not limited to the following examples.

### Synthesis Example 1

First, in order to evaluate properties, a coated conductive material is prepared. The coated conductive material is prepared by dissolving 100 parts by mole of carbon nanotube (length: 50 to 200 μm, diameter: 7 to 12 nm, surface area: ˜300 m²/g), 0.25 parts by mole of zirconium oxynitrate (Zr oxynitrate), and 0.25 parts by mole of lithium hydroxide in ethanol and uniformly mixing the solution, removing the solvent through an evaporation method, and firing the residue after at 300° C.

### Synthesis Example 2

A coated conductive material is prepared in the same manner as in Synthesis Example 1 except that the firing temperature is changed to 400° C.

### Comparative Synthesis Example 1

The same carbon nanotube as used in Synthesis Example 1 is prepared.

### Comparative Synthesis Example 2

A coated conductive material of Comparative Synthesis Example 2 is prepared by forming an about 5 nm to 7 nm-thick Al₂O₃ coating layer on the carbon nanotube surface through an atomic deposition method.

### Evaluation Example 1

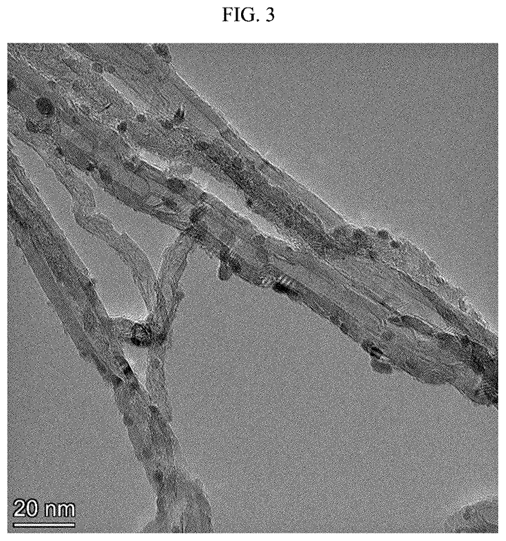

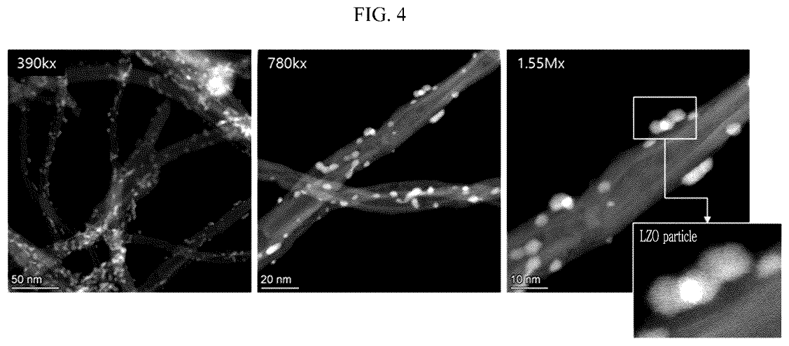

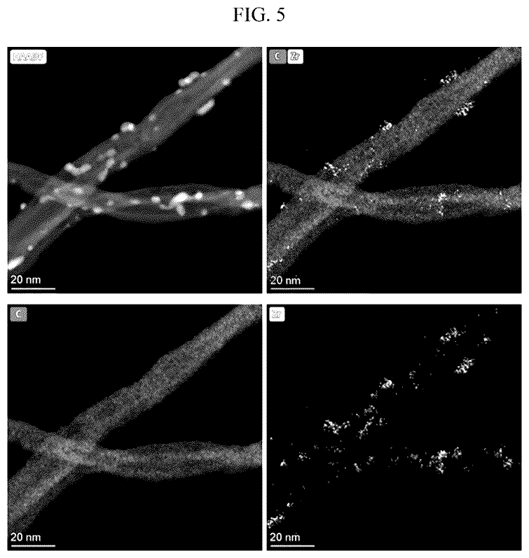

The conductive material of Synthesis Example 1 is taken an image of with a transmission electron microscope (TEM), which is shown in FIG. 3, and also, taken an image of with a scanning transmission electron microscope (STEM), which is shown in FIG. 4, and in addition, a distribution of carbon and zirconium elements is analyzed through a scanning transmission electron microscopy-energy dispersive spectroscopy (STEM-EDS), and the results are shown in FIG. 5.

Referring to FIGS. 3 to 5, a zirconium-containing coating material, for example, a coating material including lithium-zirconium composite oxide is confirmed to be located as crystalline particles of 5 nm or so on the carbon nanotube surface.

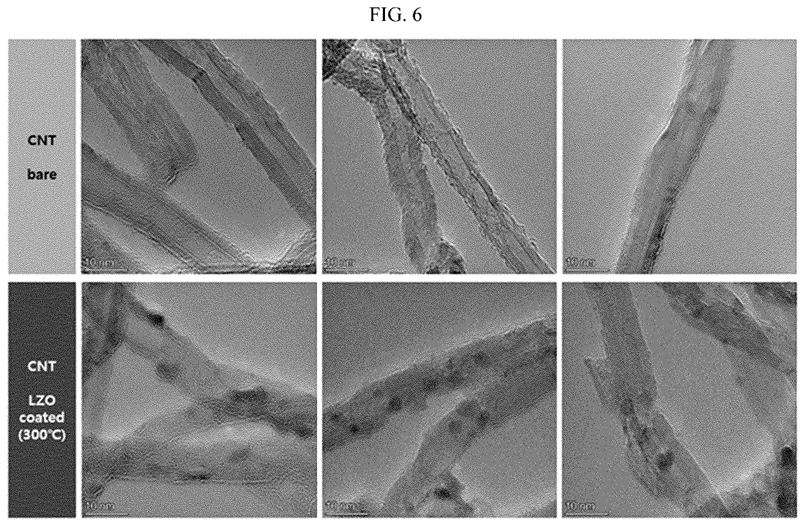

FIG. 6 shows a TEM photograph (top row) of the uncoated carbon nanotube of Comparative Synthesis Example 1 and a TEM photograph (bottom row) of the coated conductive material of Synthesis Example 1. Referring to FIG. 6, in the TEM photograph of Synthesis Example 1, a lattice structure is observed around the coating, unlike the carbon nanotube of Comparative Synthesis Example 1. Accordingly, the coating material, which is a metal oxide, is confirmed to be crystalline.

### Evaluation Example 2

In order to evaluate reactivity of a conductive material and a solid electrolyte, 3 wt % of the conductive material of Synthesis Example 1, 96 wt % of an argyrodite-type sulfide-based solid electrolyte (Li₆PS₅Cl, D50=1 μm), and 1 wt % of a polyvinylidene fluoride binder are mixed and then, coated on an aluminum current collector and dried, manufacturing an electrode having no positive electrode active material. Similarly, each electrode is manufactured by respectively using the conductive materials of Synthesis Example 2 and Comparative Synthesis Examples 1 and 2 in the same method.

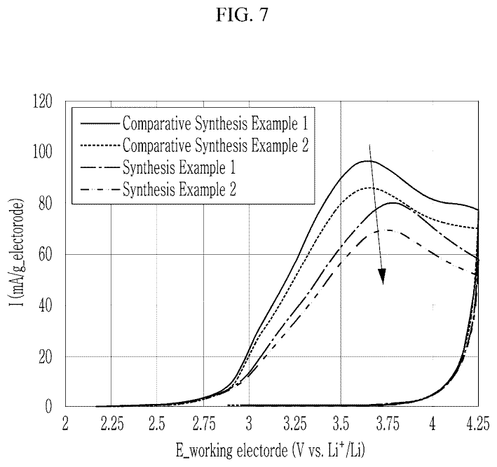

These four types of electrodes are measured with respect to a current change depending on an energy potential, and the results are shown in FIG. 7. In FIG. 7, as an area under each graph is smaller, the reactivity between conductive material and solid electrolyte may be small. Referring to FIG. 7, the graphs of the electrodes of Synthesis Examples 1 and 2 exhibit a lower peak than those of the electrodes of Comparative Synthesis Examples 1 and 2, and in addition, the peaks of Synthesis Examples 1 and 2 are shifted toward the right, which confirms that reactivity of the conductive material and the solid electrolyte is reduced and stabilized. The reactivity between conductive material and solid electrolyte in the synthesis examples is confirmed to be reduced by about 30%, compared with the comparative synthesis examples.

### Evalution Example 3

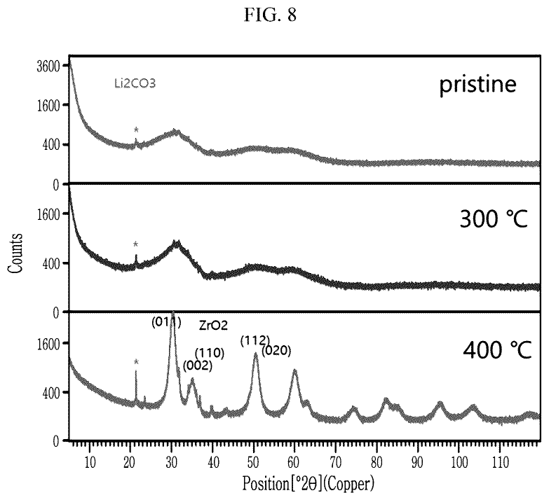

In order to accurately check the coating materials, zirconium oxynitrate and lithium hydroxide are mixed in a mole ratio of 1:1 and heat-treated at 300° C. to manufacture a lithium-zirconium composite oxide. In addition, the heat treatment temperature is changed to 400° C. to manufacture another lithium-zirconium composite oxide. The coating material before the heat treatments and the resulting materials after each heat treatment at 300° C. and at 400° C. are subjected to X-ray spectroscopy (XRD), and the results are shown in FIG. 8. In the graph of FIG. 8, star marks at the left indicate a peak of Li₂CO₃ crystals, and some peaks distributed at the right may be a peak of ZrO₂ crystals. Referring to FIG. 8, the coating material is confirmed to have crystalline Li₂CO₃ and relatively less crystalline ZrO₂, and the heat treatment at 400° C. is confirmed to increase crystallinity of the coating material. On the other hand, when heat-treated at 400° C., crystals on a (011) plane are confirmed to have a size of about 7 nm.

### Example 1

### 1. Manufacturing of Positive Electrode

99 wt % of Li_{1.06}Ni_{0.90}Co_{0.07}Mn_{0.03}O₂ as a positive electrode active material, 0.5 wt % of carbon nanotube coated with lithium zirconium composite oxide, 0.25 wt % of ZrO₂, and 0.25 wt % of LiOH are mixed and then, fired under an oxygen atmosphere at 300° C. for 1 hour, simultaneously obtaining a positive electrode active material and a conductive material which are surface-coated with the lithium-zirconium composite oxide.

85.5 wt % of the fired resultant is mixed with 13.5 wt % of an argyrodite-type sulfide-based solid electrolyte (Li₆PS₅Cl, D50=1 μm) and 1.0 wt % of a polyvinylidene fluoride binder to prepare a positive electrode composition. The prepared positive electrode composition is bar-coated on an aluminum positive electrode current collector and then, dried and compressed to manufacture a positive electrode.

### (2) Manufacturing of Solid Electrolyte Layer

An acryl-based binder (SX-A334, Zeon Chemicals L.P.) is dissolved in an isobutyl isobutyrate (IBIB) solvent to prepare a binder solution, and the argyrodite-type sulfide-based solid electrolyte (Li₆PS₅Cl, D50=3 μm) is added thereto and then, stirred in a Thinky mixer to adjust viscosity to an appropriate level. After adjusting the viscosity, 2 mm zirconia balls are added thereto and then, mixed again with the Thinky mixter to prepare a slurry. The slurry includes 98.5 wt % of the solid electrolyte and 1.5 wt % of the binder. The slurry is coated on a release PET film with a bar coater and then, dried at room temperature to form a solid electrolyte layer.

### (3) Manufacturing of Negative Electrode

After preparing a catalyst by mixing carbon black with a primary particle diameter (D50) of about 30 nm and silver (Ag) with an average particle diameter (D50) of about 60 nm in a weight ratio of 3:1, 0.25 g of the catalyst is added to 2 g of an NMP solution including 7 wt % of a polyvinylidene fluoride binder and then, mixed, preparing a negative electrode coating layer composition. This negative electrode coating layer composition is coated on a nickel foil current collector with a bar coater and then, vacuum-dried to obtain a precipitation-type negative electrode having a negative electrode coating layer on the current collector.

### (4) Manufacturing of Final All-solid-state Rechargeable Battery

The manufactured positive electrode, solid electrolyte layer, and negative electrode are cut and stacked in an order of positive electrode/solid electrolyte layer/negative electrode, and then, on the negative electrode, an elastic sheet is stacked. The obtained stack is sealed in a pouch shape and subjected to warm isostatic press (WIP) at a high temperature of 80° C. at 500 MPa for 30 minutes to manufacture an all-solid-state rechargeable battery cell. In the pressurized state, the positive electrode active material layer has a thickness of about 100 μm, the negative electrode coating layer has a thickness of about 7 μm, and the solid electrolyte layer has a thickness of about 60 μm.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

[Description of Symbols]

| | |
|---|---|
| 100: all-solid-state rechargeable battery | 200: positive electrode |
| 201: positive electrode current collector | |
| 203: positive electrode active material layer | |
| 300: solid electrolyte layer | 400: negative electrode |
| 401: negative electrode current collector | |
| 403: negative electrode active material layer | |
| 400′: precipitation-type negative electrode | 404: lithium metal layer |
| 405: negative electrode coating layer | 500: elastic layer |

1. An all-solid-state rechargeable battery, comprising
a positive electrode, a negative electrode, and a solid electrolyte layer between the positive electrode and the negative electrode,
wherein the positive electrode includes a current collector and a positive electrode active material layer on the current collector, and the positive electrode active material layer includes a positive electrode active material, a sulfide-based solid electrolyte, and a conductive material, and
the conductive material includes a carbon material having an aspect ratio of greater than or equal to 2 and a metal oxide on a surface of the carbon material, and the metal oxide includes a metal selected from Ca, Co, Ga, K, Mg, Na, Nb, Sn, Ti, V, Zn, Zr, and a combination thereof.

2. The all-solid-state rechargeable battery as claimed in claim 1, wherein
the metal oxide is included in an amount of 0.05 parts by mole to 5 parts by mole based on 100 parts by mole of the carbon material having the aspect ratio of greater than or equal to 2.

3. The all-solid-state rechargeable battery as claimed in claim 1, wherein
the metal oxide is present in a form of a particle, an island, or a film on the surface of the carbon material having the aspect ratio of greater than or equal to 2.

4. The all-solid-state rechargeable battery as claimed in claim 1, wherein
the metal oxide is present in a form of particles having a size of 0.5 nm to 30 nm on the surface of the carbon material having the aspect ratio of greater than or equal to 2.

5. The all-solid-state rechargeable battery as claimed in claim 1, wherein
the metal oxide is present in a form of crystalline particles on the surface of the carbon material having the aspect ratio of greater than or equal to 2.

6. The all-solid-state rechargeable battery as claimed in claim 1, wherein
the metal oxide includes a lithium-metal composite oxide.

7. The all-solid-state rechargeable battery as claimed in claim 1, wherein
the metal oxide includes a lithium zirconium composite oxide, a lithium titanium composite oxide, a lithium zinc composite oxide, a lithium vanadium composite oxide, a composite thereof, or a combination thereof.

8. The all-solid-state rechargeable battery as claimed in claim 1, wherein
the conductive material further includes lithium carbonate, lithium oxide, lithium hydroxide, or a combination thereof on a surface of the carbon material having the aspect ratio of greater than or equal to 2.

9. The all-solid-state rechargeable battery as claimed in claim 1, wherein
the carbon material having the aspect ratio of greater than or equal to 2 includes a carbon nanotube, a carbon nanofiber, a carbon nanowire, or a combination thereof.

10. The all-solid-state rechargeable battery as claimed in claim 1, wherein
the positive electrode includes a protective layer on the surface of the positive electrode active material and/or the surface of the positive electrode active material layer, and
the protective layer includes a metal oxide including a metal selected from Ca, Co, Ga, K, Mg, Na, Nb, Sn, Ti, V, Zn, Zr, and a combination thereof.

11. The all-solid-state rechargeable battery as claimed in claim 10, wherein
the metal oxide included in the protective layer is the same as the metal oxide included in the conductive material.

12. The all-solid-state rechargeable battery as claimed in claim 1, wherein
the sulfide-based solid electrolyte includes Li₂S—P₂S₅, Li₂S—P₂S₅—LiX (wherein X is a halogen element), Li₂S—P₂S₅—Li₂O, Li₂S-P₂S₅—Li₂₀O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are each integers, and Z is Ge, Zn, or Ga), Li₂S—GeS₂, Li₂S—SiS₂—Li₃PO₄, Li₂S—SiS₂—LiₚMO_{q} (wherein p and q are each integers and M is P, Si, Ge, B, Al, Ga, or In), or a combination thereof.

13. The all-solid-state rechargeable battery as claimed in claim 1, wherein
the sulfide-based solid electrolyte includes an argyrodite-type sulfide.

14. The all-solid-state rechargeable battery as claimed in claim 1, wherein
an average particle diameter (D50) of the positive electrode active material is 1 μm to 25 μm, and
an average particle size (D50) of the sulfide-based solid electrolyte is 0.5 μm to 5.0 μm.

15. The all-solid-state rechargeable battery as claimed in claim 1, wherein
The above positive electrode active material layer is, based on 100 wt % of the positive electrode active material layer,
55 wt % to 99.8 wt % of the positive electrode active material;
0.1 wt % to 45 wt % of the solid electrolyte;
0.1 wt % to 5 wt % of the conductive agent; and
0 wt % to 5 wt % of the binder.

16. The all-solid-state rechargeable battery as claimed in claim 1, wherein
the negative electrode includes a current collector and a negative electrode coating layer located on the current collector and including a lithiophilic metal, a carbon material, or a combination thereof, and
a lithium metal layer formed by charging between the current collector and the negative electrode coating layer.
